(19) United States
(12) Patent Application Publication
(10) Pub. No.: US 2025/0162132 A1
(43) Pub. Date: May 22, 2025

(54) HOOP ACTUATOR AND MOTION ASSISTIVE DEVICE

(71) Applicant: The Regents of the University of Michigan, Ann Arbor, MI (US)

(72) Inventors: Elliott Rouse, Ann Arbor, MI (US); Riley Pieper, Ann Arbor, MI (US); Nikko Van Crey, Ann Arbor, MI (US); Gray Thomas, Ann Arbor, MI (US); Roberto Leo Medrano, Ann Arbor, MI (US)

(21) Appl. No.: 18/874,580

(22) PCT Filed: Jun. 13, 2023
(86) PCT No.: PCT/US23/25226

§ 371 Date: Dec. 12, 2024

Related U.S. Application Data
(60) Provisional application No. 63/351,683, filed on Jun. 13, 2022.

(51) Int. Cl. B25J 9/00

(52) U.S. Cl. CPC B25J 9/0006

(57) ABSTRACT

A wearable motion assistive device such as an electromechanical exoskeleton includes an actuator that circumscribes a natural or artificial portion of the body of a user when the user wears the device. The actuator includes an interior stator, an exterior rotor, and a bearing assembly, each of which may be segmented to permit the actuator to be installed around or be removed from around the portion of the user's where the device is worn. The bearing assembly includes a plurality of small roller bearings mounted on a carrier affixed to the stator and is segmented along the carrier between roller bearings.

### TECHNICAL FIELD

The present disclosure relates generally to motion assistive devices and, more particularly, to actuators used to provide or assist appendage movement about a joint.

### BACKGROUND

Electromechanical exoskeletons can be used to reduce the metabolic cost of human musculoskeletal movement, such as movements performed while walking. Such exoskeletons use a powered actuator to provide and/or assist movement of an appendage about a joint or a simulated joint, such as foot movement about an ankle joint. With such devices, the ratio of assistive torque to the mass of the device may be referred to as torque density. With traditional central-shaft electric motors as actuators, achieving higher available torque often requires increasing the size and/or weight of the motor and/or transmission, which negatively affects torque density. Such motors also must be worn off-center such that the weight distribution of the exoskeleton is excessively uneven.

### SUMMARY

Embodiments of a wearable motion assistive device include an actuator that circumscribes a natural or artificial portion of the body of a user when the user wears the device.

In various embodiments, the actuator includes a stator and a rotor, each of which circumscribes said portion of the body of the user when the user wears the device.

In various embodiments, the actuator has a closed condition, in which the actuator fully circumscribes said portion of the body, and an open condition, in which the actuator only partially circumscribes said portion of the body, such that the actuator can be installed around or be removed from around said portion of the body in the open condition.

In various embodiments, the actuator comprises a first segment and a second segment that together circumscribe said portion of the body. The second segment is movable relative to the first segment to open or close a gap between the first and second segments such that the actuator can be installed around or removed from around said portion of the body by passing said portion of the body through the gap. The first and second segments may rotate relative to each other about a hinge axis when the actuator is changed between the open and closed conditions.

In various embodiments, the device includes a frame, an appendage support, and a transmission. The actuator is mounted on the frame, and the appendage support is configured to rotate with respect to the frame. The transmission couples the actuator with the support to transmit actuator movement to rotational movement of the appendage support with respect to the frame. The frame may extend along a leg of the user, the actuator may circumscribe the leg of the user, and the support may extend along a foot of the user when the user wears the device.

In various embodiments, the actuator is a shaftless motor comprising a stator and a rotor that rotate relative to each other about an actuator axis when the motor is energized. The motor may include a bearing assembly that maintains a gap between the stator and the rotor and centers stator with respect to the rotor. The bearing assembly may include a plurality of bearings circumferentially spaced and mounted on a carrier. Each bearing of the plurality of bearings may have a rotational axis that forms an obtuse angle with a rotational axis of the actuator.

In various embodiments, the actuator includes a stator, a rotor, and a bearing assembly, at least one of which includes a first segment and a second segment that are movable relative to each other to open or close a gap between the first and second segments. The actuator is operable to rotate the rotor when the gap is closed and installable around or removable from around said portion of the body when the gap is open.

In various embodiments, a prosthesis includes the wearable motion assistive device.

In various embodiments, an electromechanical exoskeleton includes the wearable motion assistive device. The actuator may be configured to circumscribe a natural or artificial leg of the user to assist foot movement about an ankle joint.

Embodiments of an electric motor include a stator, a rotor, and a bearing assembly, at least one of which includes a first segment and a second segment that are movable relative to each other to open or close a gap between the first and second segments. The motor is operable to rotate the rotor when the gap is closed and installable around an elongate object by passing the object through the gap when the gap is open.

In various embodiments, an electromechanical exoskeleton includes the electric motor.

Embodiments of a bearing assembly include a plurality of bearings circumferentially arranged and mounted on a carrier. The bearing assembly has an effective outer diameter at least two times greater than an outer diameter of each of the plurality of bearings.

In various embodiments, each of the plurality of bearings is a radial roller bearing or ball bearing.

In various embodiments, the carrier comprises first and second circumferential segments having respective ends that are separable from each other.

It is contemplated that any one or more of the individual features listed above, shown in the drawings, or discussed below can be combined with any one or more of the same in any technically feasible combination to define an invention.

### BRIEF DESCRIPTION OF THE DRAWINGS

FIG. 1 illustrates various embodiments of a wearable motion assistive device being worn by a user;

FIG. 2 is a perspective view of a portion of an illustrative wearable motion assistive device in the form of an electromechanical exoskeleton;

FIG. 3 is a side elevation view of the device of FIG. 2;

FIG. 4 is a perspective view of a segmented actuator illustrated in a closed condition;

FIG. 5 is the segmented actuator of FIG. 4 illustrated in an open condition;

FIG. 6 is a perspective view of a closure for a segmented actuator illustrated with the actuator in the closed condition;

FIG. 7 is the closure of FIG. 6 illustrated with the actuator in the open condition;

FIG. 8 is an exploded view of the segmented actuator of FIGS. 4 and 5;

FIG. 9 is a side view of the segmented actuator of FIG. 8;

FIG. 10 is a top view of a bearing assembly for use with a segmented actuator;

FIG. 11 is a schematic top view of a bearing of the bearing assembly of FIG. 10;

FIG. 12 is a top perspective view of a carrier segment of the bearing assembly of FIG. 10;

FIG. 13 is a bottom perspective view of the carrier segment of FIG. 12;

FIG. 14 is a perspective view of a portion of another example of a segmented actuator;

FIG. 15 is a perspective view of a rotor frame segment and flux ring segment of the actuator of FIG. 14;

FIG. 16 is an exploded view of a segment of the actuator of FIG. 14;

FIG. 17 is an exploded view of a portion of a stator assembly of the actuator of FIG. 14;

FIG. 18 is a perspective view of the portion of the stator assembly of FIG. 17;

FIG. 19 is a cross-sectional view of the actuator of FIG. 14;

FIG. 20 is a schematic diagram of stator windings for use with a segmented actuator; and

FIGS. 21(a)-21(d) schematically illustrate operation of a dual-head encoder system for a segmented actuator.

### DESCRIPTION OF EMBODIMENTS

Described below is a wearable electromechanical exoskeleton employing an actuator that circumscribes a portion of the body of the user when the user wears the exoskeleton. The actuator has a ring or hoop form factor, thus providing a relatively large diameter and a correspondingly large torque and torque density. This form factor can equally distribute the weight of the actuator around the portion of the body surrounded by the actuator, and the larger torque capability enables use of a transmission with a smaller gear ratio. A smaller gear ratio can reduce reflected inertia and increase the ease of backdriving.

While described below in the context of an exoskeleton, the actuator, transmission, bearing assembly, and other components and concepts disclosed herein are equally applicable to other human or animal motion assistive devices such as orthoses and prostheses. For purposes of this disclosure, the terms “exoskeleton” and “orthosis” may be considered interchangeable, the main difference being the intended result of the device. Exoskeletons are primarily intended to reduce the metabolic cost of appendage movement, while orthoses are primarily intended to assist appendage movement of a user with an appendage pathology. Prostheses are motion assistive devices that replace all or part of one or more natural appendages and/or joints of the body. In the case of a prosthesis, the body part circumscribed by the actuator, the appendage being moved by the actuator, and/or the joint the appendage moves about may be artificial.

As used herein, an appendage is any natural or artificial body part extending from a natural or artificial joint to a free end. Human appendages thus include upper limbs (arms), lower limbs (legs), and the head, each of which extends from a joint at the torso. Similarly, the forearm is an appendage of the upper arm extending from the elbow joint, the hand is an appendage of the arm extending from the wrist joint, each finger is an appendage of the hand, and each finger has an appendage extending from each finger joint. The same is true for the legs, feet, and toes.

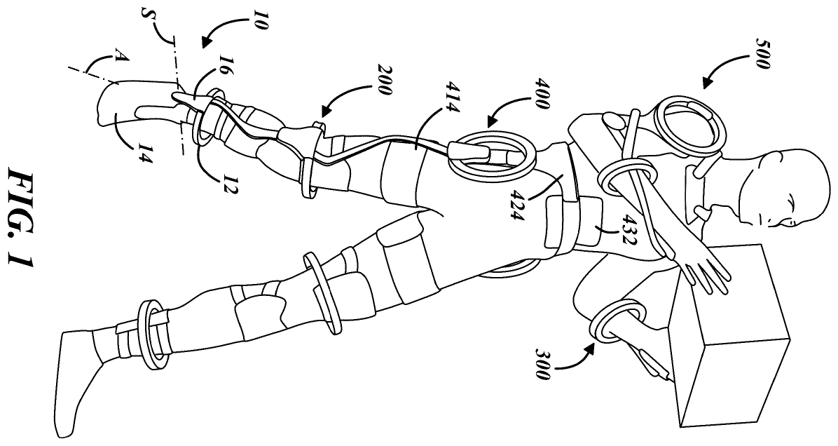

In the example of FIG. 1, a wearable electromechanical exoskeleton 10 employs a ring or hoop actuator 12 worn around the lower part of the leg to assist foot movement about an ankle joint. Rotational motion of the actuator 12 about an actuator axis A is converted to rotational motion of an appendage support 14 about a support axis S via a transmission 16. Here, the appendage support 14 is in the form of a shoe insert coupled with an output of the transmission 16. The actuator 12 and transmission 16 may be braced at a fixed location relative to the user's lower leg. The appendage support 14 moves about the support axis S, which is also at a fixed location relative to the lower leg.

The disclosed exoskeleton can be employed at other parts of the body to assist or provide movement of a natural or artificial appendage about a natural or artificial joint. FIG. 1 illustrates some examples, including the ankle joint exoskeleton 10 configured to facilitate movement of the foot about the ankle joint. A knee joint exoskeleton 200 may include a hoop actuator worn around the upper leg and an appendage support below the knee configured to move the lower leg about the knee joint. An elbow joint exoskeleton 300 may include a hoop actuator worn around the forearm and an appendage support near the wrist configured to move the forearm about the elbow joint. In some applications, the hoop actuator can be worn without circumscribing a portion of the body while still taking advantage of the high torque density of the hoop actuator. For example, a hip joint exoskeleton 400 may include a hoop actuator worn at the hip and an appendage support around the upper leg configured to move the upper leg about the hip joint. Or a shoulder joint exoskeleton 500 may include a hoop actuator worn at the shoulder and an appendage support around the upper arm configured to move the upper arm about the shoulder joint.

Certain aspects of the hoop actuator described below make it useful in other non-exoskeleton applications, including applications in which a rotational actuator is required to surround an elongate object, the ends of which are not accessible to pass through the center of the actuator. Other aspects of the hoop actuator described below are useful in applications in which large diameter bearings are required or where the gap between concentrically rotating components requires adjustment or fine-tuning.

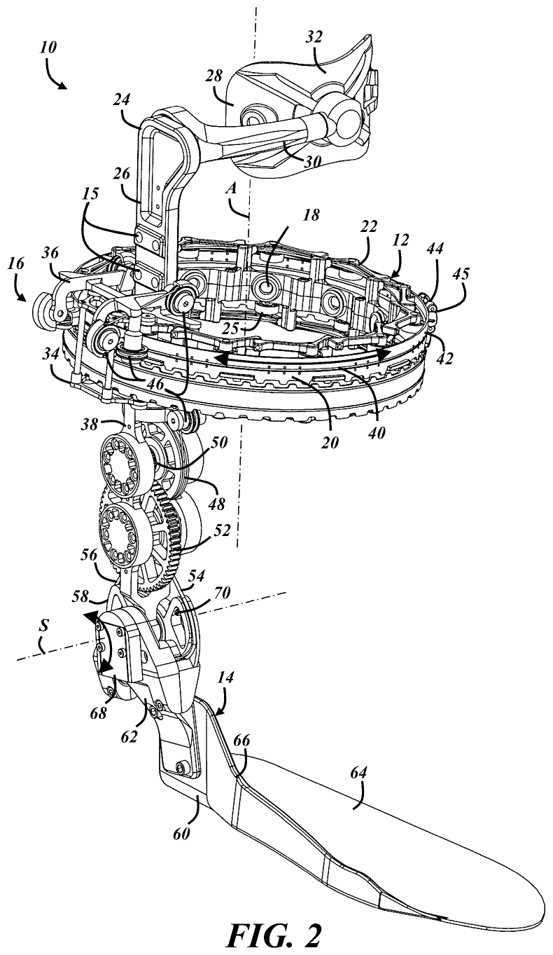

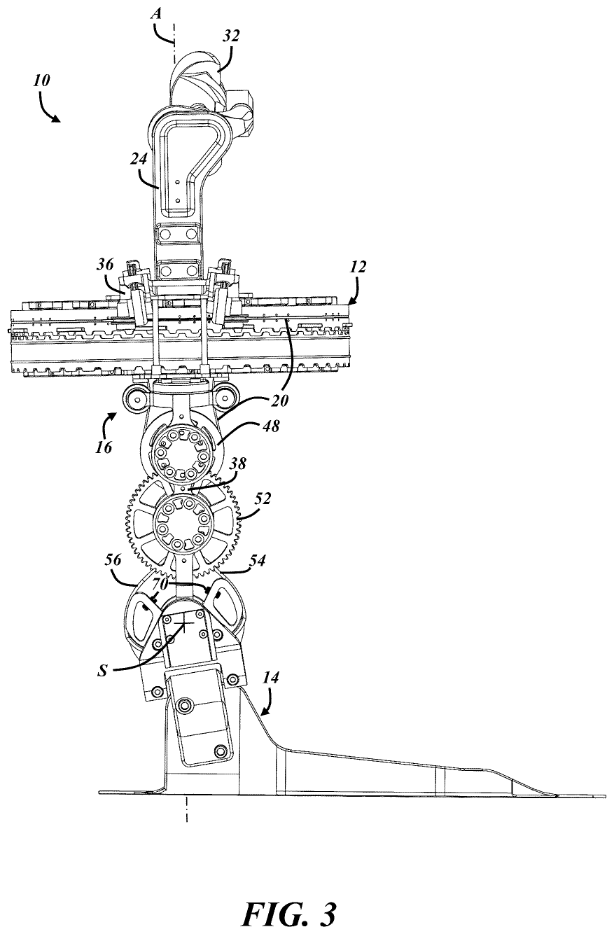

FIG. 2 is a perspective view of a portion of an illustrative wearable electromechanical exoskeleton 10, including an actuator 12, an appendage support 14, and a transmission 16 that transmits motion and torque from the actuator to the appendage support. Optional housings and covers are omitted in FIG. 3 for a better view of the working components. In this example, the actuator 12 is a hoop actuator in the form of a shaftless electric motor. The motor 12 includes an interior stator 18, an exterior rotor 20, and at least one bearing assembly 22, 25 that centers the stator within the rotor and maintains a gap between the stator and rotor. The illustrated example include an upper bearing assembly 22 and a lower bearing assembly 25 that enable low friction rotational movement of the rotor 20 relative to the stator 18.

The motor 12 is rigidly mounted to a frame 24 via the stator 18 or other stationary component of the motor, such as a housing. The frame 24 includes a motor mount 26 extending in the axial direction of the motor 12, which is mounted at the lower end of the motor mount. Additional motor mounting locations 15 are provided along the length of the motor mount 26. The frame 24 also includes a brace 28 rigidly mounted at the upper end of the motor mount 26. The brace 28 includes a crossmember 30 extending perpendicularly from the motor mount 26 and a contoured plate 32 configured to mate with the front side of the lower leg of the user. The exoskeleton 10 may also include a strap or other suitable fastening system to securely and removably fix the frame 24 to the leg of the user when the leg is extended through the center of the motor 12. Such a strap may be configured to wrap around the same part of the body that the motor 12 surrounds to fix the contoured plate in position there. The illustrated exoskeleton is configured for use with the right foot and leg of the user.

The transmission 16 includes a transmission frame 34 carrying a series of pulleys and/or gears and one or more transmission cables. The transmission frame 34 is located at a fixed position relative to the main frame 24 and motor 12 and may be mounted to either of those components or any other component that is stationary relative to the stator 18 and frame 24. The illustrated transmission frame 34 includes an upper portion 36 carrying pulleys and a lower portion 38 carrying pulleys and gears. A first transmission cable 40 has a first end 42 anchored at a first location along the exterior of the rotor 20, and an opposite second end 44 anchored at a second location along the rotor near the first end of the cable. Both ends 42, 44 of the cable 40 may be anchored to the rotor 20 by a cable tensioner 45 configured to tighten or loosen the cable between its ends.

The cable 40 extends from the first end 42 along a circumferential groove in the rotor 20 to a series of pulleys 46 mounted on the upper portion 36 of the transmission frame 34. The pulleys 46 route the cable 40 radially away from the motor 12, up and over the stator 18 and rotor 20, and down through the center of the motor to a friction pulley 48 mounted on the lower portion 38 of the transmission frame 34. From the friction pulley 48, the cable 40 is routed around another series of pulleys on the opposite side of the upper portion 36 of the transmission frame 34, back up through the open center of the motor 12, radially outward over the stator 18 and rotor 20 to the exterior of the motor, and back into and along the circumferential groove of the rotor to the second end 44 of the cable. This first transmission stage thus converts rotational motion about the actuator axis A to rotational motion of the pulley 48 about an axis parallel with the appendage support axis S.

A first gear 50 mounted on the pulley 48 meshes with and turns a larger second gear 52. Second and third cables 54, 56 anchored near the center of the second gear 52 are routed around guides 58 and are anchored at their opposite ends to the appendage support 14, which is a foot support in this case. The guides 58 are part of the appendage support and rotate about the support axis S with the rest of the support 14. In some embodiments, the gears 50, 52 are replaced with pulleys. Pulleys may be preferred due to their simplicity, smaller packaging envelope, and lower weight, compared to gears. In some cases, however, the torque being transmitted from one rotational element to another is too high to rely on friction alone to rotate a pulley, and gears or cable anchor points must be relied on.

The appendage support 14 is rotatably mounted on the lower portion 38 of the transmission frame 34 and includes the cable guides 58, a support plate 60, and a bracket 62 that couples the support plate with an axle or other rotatable mounting feature of the transmission frame. The support plate 60 includes a support portion 64 that extends along the bottom of the user's foot and can be configured to fit along the insole portion of a shoe. The support plate 60 includes a sidewall 66 extending from the support portion 64 and serves to mount the support plate to the bracket 62. The appendage support 14 may also include an encoder 66 to track the angular location of the support 14 relative to the support axis S and/or transmission frame. The angular range of motion of the support 14 may be adjustable. In the illustrated example, threaded adjusters 70 (e.g., set screws) are provided in the cable guides 58 and can be axially adjusted to provide positive mechanical stops for the appendage support when the adjusters contact the lower portion 38 of the transmission frame 34.

FIG. 3 is a side elevation view of the exoskeleton 10 of FIG. 2 with some of the components labeled with the same reference numerals, including the motor 12, appendage support 14, transmission 16, first cable 20, frame 24, upper transmission frame 36, lower transmission frame 38, friction pulley 48, gear 52, second and third cables 54, 56, and range of motion adjusters 70.

In the illustrated embodiment, where the appendage to be supported and moved relative to a joint is the user's foot, a shoe may conveniently be used to effectively secure the support 14 to the foot. In other examples, additional straps or attachments may be necessary. For instance, in the example of the hip joint exoskeleton 400 of FIG. 1, the stationary frame 424 is fixed along the side of the user's torso via a front brace 432 and a strap or belt around the user's waist, and the appendage support 414 is a leg support affixed to the back side of the upper leg via a strap or belt around the user's upper leg.

In the example of FIGS. 2 and 3, the hollow space at the center of the motor 12 is sized so that the user can extend their foot from above and through the center of the motor to place the actuator 12 around the lower leg. In some cases, this sizing makes the actuator unnecessarily large to achieve its assist function. For instance, in embodiments where the transmission 16 is packaged in a shorter envelope, the size of the inner diameter of the actuator 12 required to go over the foot and ankle of the user may be much larger than the lower part of the lower leg just above the ankle. This can make the actuator 12 unnecessarily heavy and cumbersome to use. The same may be true for an exoskeleton in which the actuator is worn around the wrist—i.e., to be large enough to fit over the hand, the actuator may be unnecessarily large to perform its function.

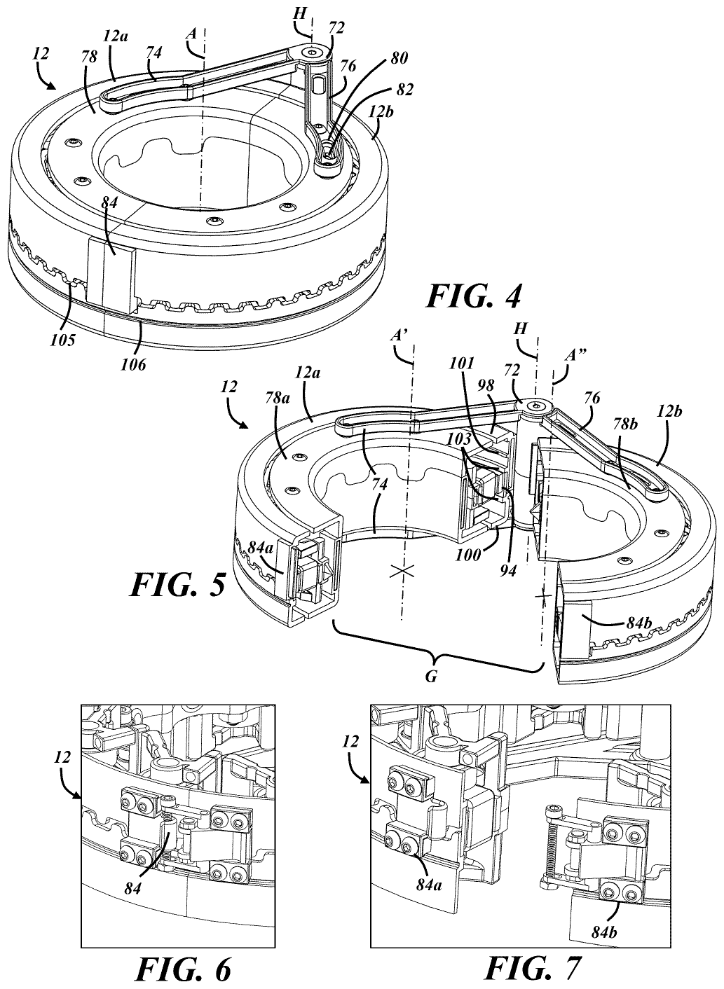

FIGS. 4 and 5 illustrate a segmented or splitable actuator 12 configured to open and close in the manner of a clamshell or clasping bracelet. FIG. 4 shows the actuator 12 in a closed condition, in which the actuator is operable to rotate the exterior rotor 20 relative to the interior stator 18 when energized. FIG. 5 shows the actuator 12 in an open condition, in which a break or gap G is formed in the ring-shaped structure so that a body part of the user can pass through the gap to install the actuator around the body part or to remove the actuator from around the body part.

The illustrated actuator 12 is in the form of an electric motor and includes a first segment 12a and a second segment 12b pivotably coupled together for cooperative relative movement about a hinge axis H, which is defined by a hinge assembly 72. The hinge assembly 72 includes first and second pairs of arms 74, 76. Each pair of arms 74, 76 includes an upper arm and a lower arm respectively mounted to upper and lower faces of the motor or a motor housing 78. An opposite end of each pair of arms 74, 76 pivots with a respective sleeve about a hinge pin of the hinge assembly 72. Through-openings 80, 82 are respectively formed through at least one of each pair of arms and through the housing 78 and the corresponding location for routing cables or wires, such as encoder or stator winding leads.

The two segments 12a, 12b of the illustrated actuator 12 share the rotational axis A when in the closed condition. When in the open condition, each segment 12a, 12b has its own respective axis A′, A″ spaced away from the other. The segmented actuator 12 further includes a closure 84 configured to reversibly maintain the closed condition of the actuator. The closure 84 can be of any suitable type, such as a magnetic closure or a mechanical latch, and may incorporate alignment features, such as a protrusion on one side 84a of the closure 84 and a complementary receptacle on the other side 84b of the closure. FIGS. 6 and 7 illustrate one example of a latch-type closure 84 with the actuator 12 in respective closed and open conditions. In some embodiments, the actuator segments 12a, 12b are maintained in the closed position by a plurality of closures such that the segments are completely separable from each other as arc-shaped segments that are not hinged together. More than two segments are possible as well.

It is noted that here, and in the following description of the segmented actuator 12, each component is referred to as a whole with a reference numeral, and each first and second segment of any particular component is referred to with the same reference numeral followed by the letters “a” or “b.” For instance, the housing 78 of FIGS. 4 and 5 has first and second segments 78a and 78b, whether in the closed condition or the open condition. In some cases, a segment may be labeled without the “a” or “b” designation with the understanding that reference is being made to the whole component. In some cases, the individual segments are labeled without the whole component being labeled, with the understanding that any group of segments with the same numeric designation make the respective whole component. Additionally, while the following description makes reference to a segmented version of the actuator, a non-segmented actuator such as the actuator of FIGS. 2 and 3 can be constructed in the same or similar manner as the segmented version with each component being a single continuous ring or hoop rather than a segmented ring or hoop.

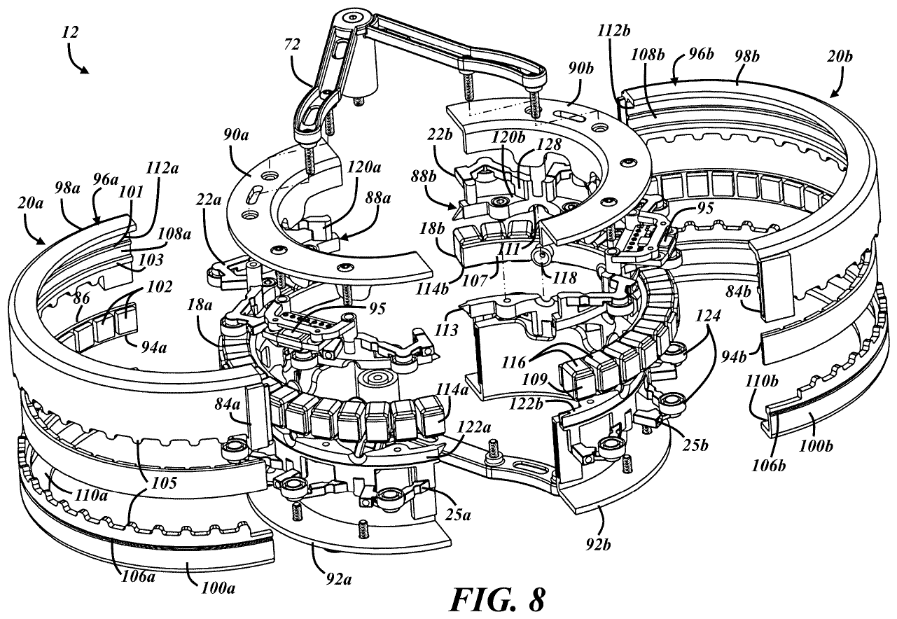

FIG. 8 is an exploded view of the segmented actuator 12 of FIGS. 4 and 5. The actuator 12 includes the stator 18, the rotor 20, the upper and lower bearing assemblies 22, 25, the hinge assembly 72, upper and lower stator covers 90, 92, and one or more encoders 95.

The rotor 20 includes a magnetic flux ring 94 supported in a rotor frame 96, which includes upper and lower rotor frame members 98, 100 in this example. The motor housing 78 of FIGS. 4 and 5 is defined by the stator covers 90, 92 and the rotor frame 96. The flux ring 94 includes a ferromagnetic (e.g., low-carbon steel) ring 86 and a plurality of permanent magnets 102 arranged circumferentially about the actuator axis with sequentially alternating radially inward facing north and south poles. The flux ring 94 is sandwiched between the upper and lower rotor frame members 98, 100 and supported between radially inward projecting ribs or lips 103 provided on the frame members, as shown in FIG. 5. Each rotor frame member 98, 100 has axially projecting teeth 104 along its outer perimeter that fit between the teeth of the other frame member to form a serpentine-shaped circumferential groove 105 (FIG. 4) along the exterior of the rotor. The groove 105 can accommodate an epoxy or other suitable adhesive to bond the rotor frame members 98, 100 together as the rotor frame 96 supporting the flux ring 94.

In this example, the rotor frame 96 includes a cable groove 106 along the exterior of the rotor 20 to accommodate a transmission cable 40 as in the example of FIGS. 2 and 3. The illustrated rotor frame 96 also includes upper and lower bearing tracks 108, 110 and a radially inwardly facing readable encoder surface 112 extending circumferentially along an inner surface of the rotor frame 96. The rotor frame 96 also accommodates the closure(s) 84.

The stator 18 includes a ferromagnetic stator core 114 including a circular base ring 107 with radially outward extending poles 109. Electrical wiring is wound around each pole 109 and in the gaps between the stator core poles to form a coil 116 of wire (shown schematically in FIG. 8) around each stator core pole. The stator 18 is clamped between the upper and lower bearing assemblies 22, 25 and includes locators 118 projecting radially inward from the stator core 114 for locating the bearing assemblies during assembly, and to prevent angular movement between the stator 18 and bearing assemblies when assembled. Each bearing assembly 22, 25 includes a portion of a recess and opening 111 to accommodate the locators 118 of the stator 18.

Each bearing assembly 22, 25 includes a respective carrier 120, 122 and a plurality of individual bearings 124 mounted on each carrier. The bearings 124 are circumferentially spaced about the actuator axis. Each bearing 124 in this example is a sealed radial ball bearing and is axially spaced from the stator 18 to be aligned with a corresponding one of the bearing tracks 108, 110 of the rotor 20. The inner bore and race of each bearing 124 is mounted on one of the carriers 120, 122, and the outer perimeter and race of each bearing 124 is in contact with the corresponding track 108, 110 of the rotor frame 96 such that the outer race of each bearing 124 rotates about the respective inner race when the rotor 20 rotates about the stator 18.

The carriers 120, 122 are bolted or otherwise fixed together with the stator 18 sandwiched between them. The carriers 120, 122 thus act as a frame for the stator in this example. The circumferential ends of each segment 120a, 120b, 122a, 122b of each carrier include a locating feature 113 (e.g., a projection or a receptacle) to help axially align the bearing assembly segments 22a, 22b, 25a, 25b in the closed condition of the actuator 12. An epoxy or other suitable adhesive may be applied between the carriers 120, 122, such as at each locator 118 and corresponding recess 111. In other embodiments, the stator 18 may include a dedicated frame.

The illustrated actuator 12 includes two linear encoders 95 mounted on the carrier 120 of the upper bearing assembly 22 and aligned with the readable encoder surface 112. As discussed further below, the encoders 95 are circumferentially spaced from each other by an angle that is greater than or less than 180 degrees.

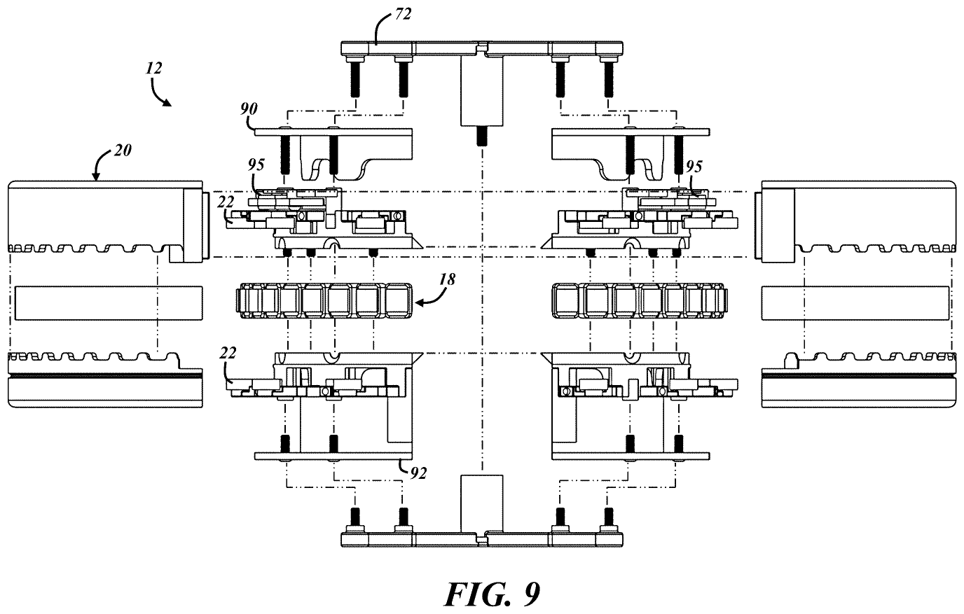

FIG. 9 is an exploded side view of the segmented actuator 12 of FIGS. 4, 5 and 8 with several of the components labeled with appropriate reference numerals.

The segmented actuator design presents numerous problems that are not encountered with conventionally constructed electric motors. For example, in conventional motors, each phase of electrical windings of the stator is continuous—i.e., wound several times around and through the stator core to facilitate continuous electric current along the entire 360-degrees of the stator. There is no way to split such continuous windings without causing an electrical open condition in each winding. Additionally, splitting an otherwise continuous encoder tape creates a discontinuity in the tape which will cause a read error when the discontinuity is encountered by the encoder. Also, a conventional sealed radial ball bearing is not practical to center the rotor and stator and maintain a consistent gap between the rotor and stator. This is because a sealed bearing cannot be split and functionally reassembled, and because, in a shaftless motor, the required size of a bearing near the perimeter of the motor is very large. Large diameter bearings are expensive and heavy. Certain components of the actuator 12 are adapted to address these previously unencountered problems caused by the segmented actuator form factor.

FIG. 10 is a top view of a portion of the segmented actuator 12, illustrating the stator 18, the rotor 20, and an upper bearing assembly 22 that addresses one or more of the above-mentioned problems with conventional motor bearings. The lower bearing assembly 25 and carrier 122 is not visible in FIG. 10 but is substantially identical to the upper bearing assembly 22 except without the encoders 95 mounted thereon. The illustrated bearing assembly 22 includes a plurality of individual and relatively small diameter bearings 124 affixed to the carrier 120. This configuration may be referred to as a “bearing of bearings.”

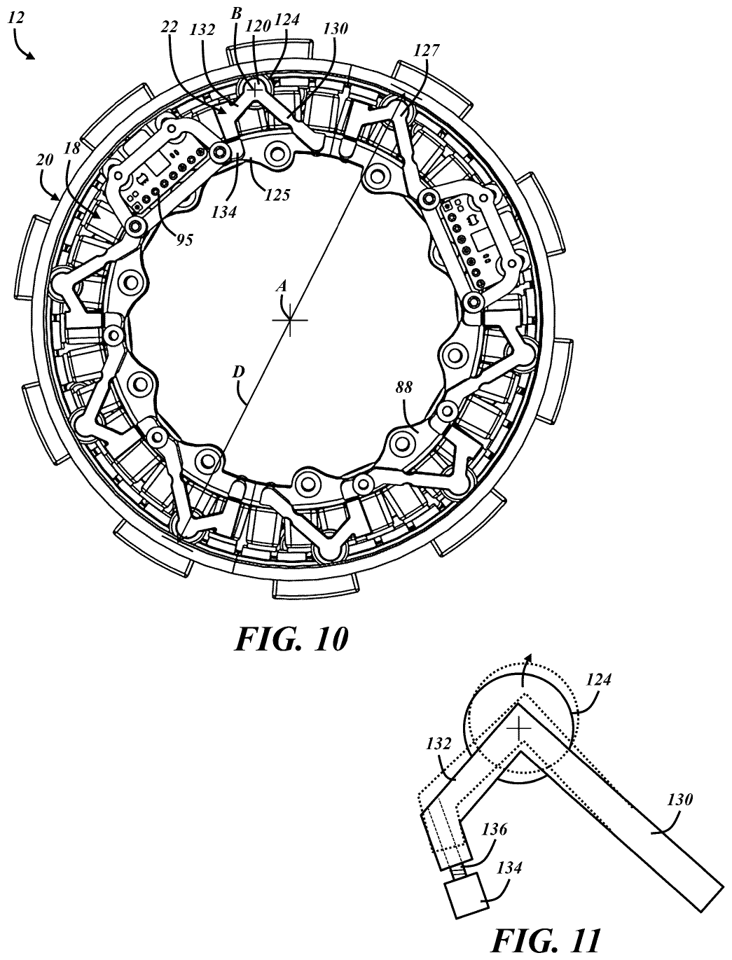

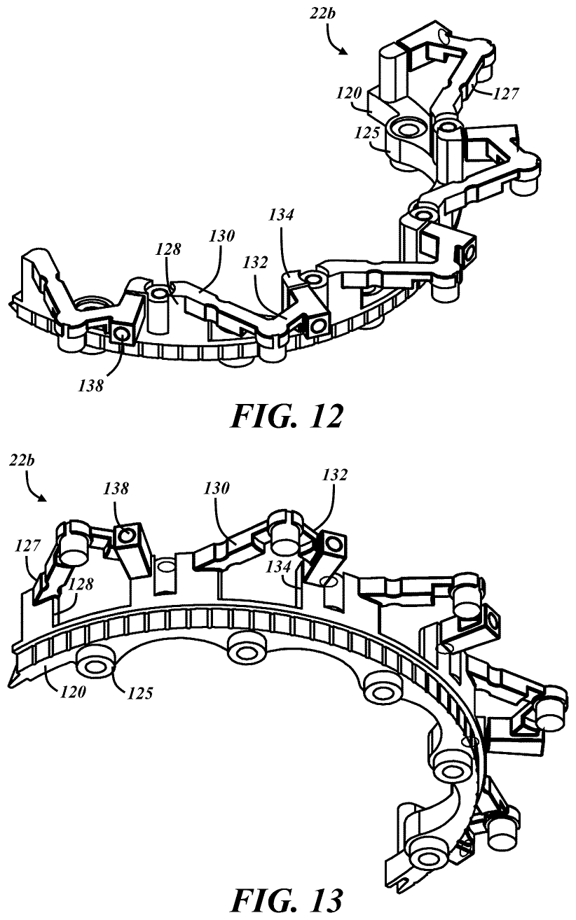

The carrier 120 includes a clamping portion 125 and a mounting portion 127 (FIGS. 9, 12 and 13). The stator 18 is clamped between the clamping portion 125 of each carrier 120, 122, and each clamping portion 125 is in the form of a radially inner ring. Each bearing 124 is mounted on the mounting portion 127 of the carriers 120, and each mounting portion 127 is axially spaced from the respective clamping portion 125 by an axial spacer 128 (FIGS. 12-13) to align the bearings with the respective bearing track 108, 110.

Each carrier 120, 122 maintains each individual bearing 124 at the same position relative to other individual bearings on the same carrier. Each mounting portion 127 of each carrier 120, 122 has a plurality of carrier arms 130 extending outward from one of the axial spacers 128. Each bearing 124 is mounted at a bearing axis B defined at an end of each arm 130. The illustrated carrier 126 further includes a plurality of adjuster arms 132, each extending radially inward from one of the bearing axes B. In this example, each carrier arm 130 and corresponding adjuster arm 132 are made as one piece in a V-shape. The V-shaped structure can be made as one piece with the axial spacer 128 or separately made and rigidly mounted with respect to clamping portion 125 of the respective carrier 120, 122. Each adjuster arm 132 has a free end aligned with an adjuster block 134, which may be integral with the clamping portion 127 as shown.

The illustrated bearing assembly uses multiple small, and much less expensive, bearings 124 rather than one large bearing to maintain the rotor-to-stator gap and does so in a way that permits the bearing assemblies 22, 25 to be segmented to accommodate the conversion of the actuator 12 between the open and closed conditions. In particular, each carrier 120, 122 can be made in two or more arcuate segments that together form a segmented ring supporting the bearings 124. The benefits of this type of “bearing of bearings” are not limited to a segmented actuator. Indeed, very similar bearing assemblies 22, 25 are illustrated in the actuator of FIGS. 2 and 3, with the difference being a one-piece carrier. A non-segmented bearing assembly can still realize at least the cost and weight advantages noted above. Each bearing assembly 22, 25 has an effective outer diameter D at least two times greater than an outer diameter of each of the plurality of bearings 124. In the illustrated example, the effective diameter D of the bearing assembly 22 is in a range from 10 times to 15 times greater than the outer diameter of the individual bearings 124.

Additionally, the illustrated bearing assembly 22 enables an adjustable gap between the stator 18 and rotor 20. FIG. 11 schematically illustrates the adjustability of the position of one of the bearings 124 of the bearing assembly 22 relative to the actuator axis. In this example, an adjuster 136 (e.g., a set screw) is advanced from the adjuster arm 132 toward the adjuster block 134, which causes the carrier arm 130 to deflect radially outward. As shown in FIG. 10, the carrier arm 130 may include a narrowed section to facilitate predictable flexure. The deflected position is illustrated in broken lines in FIG. 11, and the amount of deflection is exaggerated for purposes of illustration. The illustrated adjustment would locally increase the gap between the stator 18 and rotor 20. The radial position of each individual bearing 124 can thus be adjusted until the gap is consistent about the entire circumference of the stator 18. This is an advancement over conventional bearings apart from the bearing assembly's use in a segmented actuator and exoskeleton. In particular, when the rotor and stator of a conventional motor are non-concentric, there is no way to compensate to align the two components along the same axis.

FIGS. 12 and 13 are top and bottom perspective views of one of the bearing assembly segments 22b of FIG. 10, in which the bearings 124 are omitted. These views illustrate the axial spacing required between the carrier arms 130 and the clamping portion 125 of the carrier 22 to align the bearings 124 with the appropriate bearing track of the rotor 20. These views also show radial bores 138 in the ends of the adjuster arms 132 to accommodate an adjuster 136.

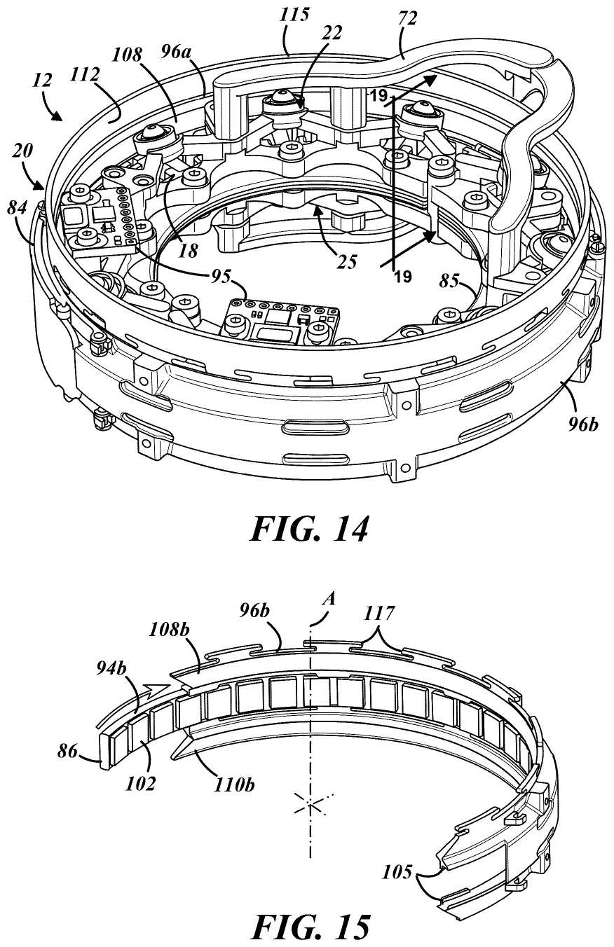

FIG. 14 is a perspective view of another embodiment of the segmented actuator 12, including the stator 18, the rotor 20, the upper and lower bearing assemblies 22, 25, the hinge assembly 72, and the one or more encoders 95. In this example, the stator 18 includes a dedicated stator frame 85, and the rotor 20 includes a separately provided encoder ring 115 attached to the rotor frame 96. The covers of the previous embodiment are omitted in FIG. 14.

In this example, each of the first and second segments 96a, 96b of the rotor frame 96 is a one-piece monolithic component (e.g., aluminum) configured to receive respective segments 94a, 94b of the magnetic flux ring 94 as illustrated in FIG. 15. Here, the ferromagnetic portion 86 of each flux ring segment 94a, 94b is slidingly received by a circumferentially extending groove on the radially inward facing side of the respective segment of the rotor frame 96. The flux ring 94 is adhered or otherwise affixed to the rotor frame 96. The groove in this example is discontinuous and formed by axially extending tabs 105 spaced along the inner diameter of the rotor frame 96. The tabs 105 aid in maintaining the semi-circular shape of each flux ring segment 94a, 94b. The one-piece rotor frame 96 eliminates the need to affix upper and lower rotor frame members together and provides better dimensional tolerances when the flux ring 94 is received.

As in the previous example, the rotor frame 96 may at least partially define the motor housing. The illustrated rotor frame 96 also includes the upper and lower bearing tracks 108, 110. The radially inward facing readable encoder surface 112 is provided by the encoder ring 115 extending circumferentially along the rotor 20. The encoder ring 115 is also made in first and second segments and is attached along an axial end the rotor frame 96 via interlocking features 117 and/or adhesive. The closure 84 in this example is a tri-fold arcuate closure similar to that of a metal-banded watch clasp.

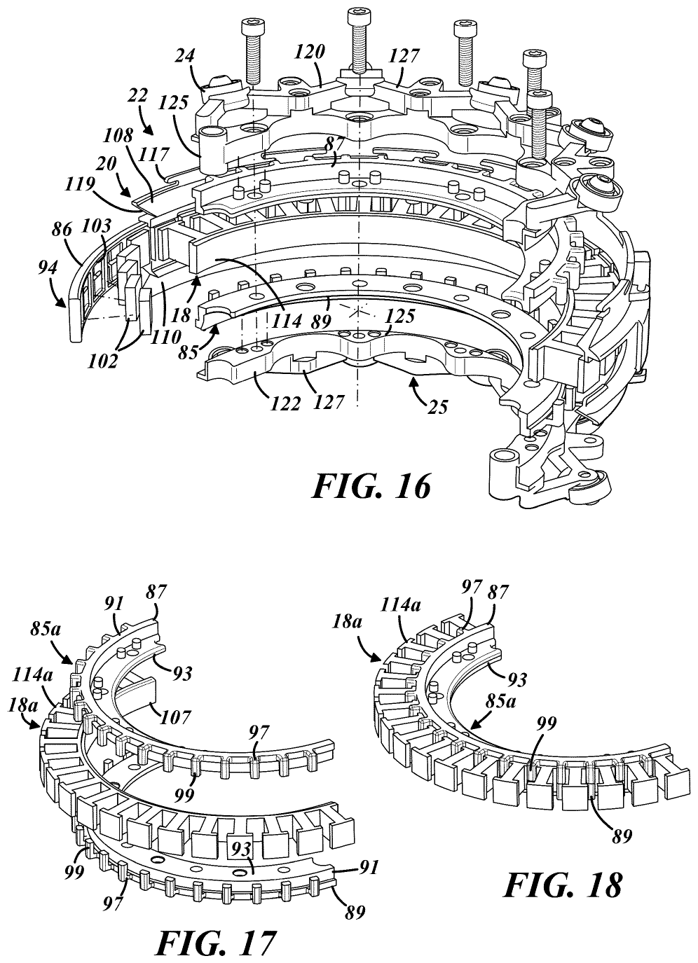

With reference to the exploded view of FIG. 16, the stator core 114 (shown without windings) is essentially the same as in the previous example and is similarly clamped between the carriers 120, 122 of the upper and lower bearing assemblies 22, 25. However, the stator 18 does not entirely rely on the carriers 120, 122 as a frame and includes its own stator frame 85 including upper and lower stator frame members 87, 89, as described further below. The illustrated rotor 20 includes an individual recess 103 formed along the radially inner surface of the ferromagnetic ring 86 for each one of the magnets 102 of the flux ring 94. The recesses 103 may be machined along the ring 86 for precision placement of the magnets 102.

FIG. 17 is an exploded view of the first stator segment 18a, which includes the first stator core segment 114a and first stator frame segment 85a, and FIG. 18 shows the components of FIG. 17 assembled. Each of the upper and lower members 87, 89 of the stator frame 85 includes a radially central annular ring 91, a flange 93 extending radially inward from the ring 91, teeth 97 extending radially outward from the ring 91, and fingers 99 extending axially from the teeth 97. The teeth 97 of each of the upper and lower members 87, 89 extend toward each other along the base ring 107 of the stator core 114 and into the gap between adjacent poles 109 of the stator core 114.

The upper and lower members 87, 89 are adhered or otherwise attached together to form the stator frame 85 with the base ring 107 of the of the stator core 114 located axially between the teeth 97 of the upper and lower members 87, 89 and radially between the annular ring 91 and fingers 99 of each of the upper and lower members 87, 89. The stator frame 85 serves to help maintain the semi-circular shape of each of the stator segments 18a, 18b with the radially extending flanges 93 providing stiffness that resists radial deformation.

Each of the upper and lower members 87, 89 of the stator frame 85 includes through-holes and locators along the respective flange 93. The through-holes accommodate fasteners that clamp the stator brace 85 and/or stator 18 between the carriers 120, 122 of the upper and lower bearing assemblies 22, 25. In this example, the locators are protrusions received by recesses in the upper and lower carriers 120, 122.

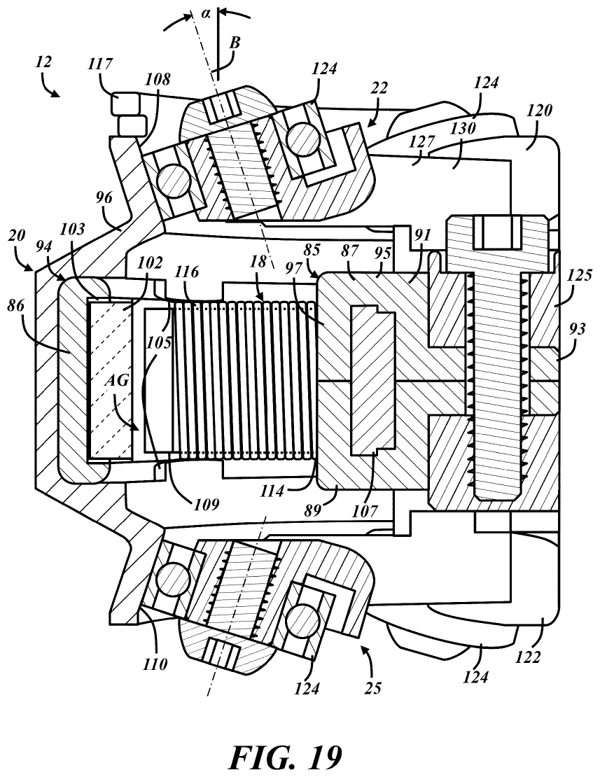

Referring again to FIGS. 14 and 16, each bearing assembly 22 is similar to the previously described bearing assemblies in that each includes a plurality of individual bearings 124 circumferentially spaced about the actuator axis A and supported by one of the carriers 120, 122 with the outer perimeter of each bearing 124 in contact with the corresponding track 108, 110 of the rotor frame 96 such that the outer race of each bearing 124 rotates about its inner race when the rotor 20 rotates about the stator 18. Each carrier 120, 122 also similarly includes a clamping portion 125 and a mounting portion 127 axially spaced from the clamping portion 125. However, in this case the bearings 124 are mounted at radially fixed positions—i.e., they are not adjustable—and the rotational axis B of each bearing 124 is angled with respect to the actuator axis A as best shown in the cross-sectional view of FIG. 19, discussed below. In this case, each bearing 124 is mounted at the junction of two carrier arms 130 that extend radially outward from the clamping portion 125 of each carrier 120, 122.

The cross-sectional view of FIG. 19 is taken through a radial-axial plane with several of the above-described components labeled with the appropriate reference numerals, including the stator 18, the rotor 20, and the upper and lower bearing assemblies 22, 25, which include respective upper and lower carriers 120, 122 and a plurality of bearings 124 mounted on the carriers. In the illustrated example, the rotational axis B of each bearing 124 forms an angle α with the actuator axis. The angle α is obtuse and may be in a from 5° to 30°. In the illustrated example, the angle α is obtuse and may be in a range from 15° to 20°. Bearing load-life data can be used to determine the optimum angle α. The surface of each bearing track 108, 110 of the rotor 20 is a conical surface in contact with the outer diameter of each bearing 124. The radially extending lips 101, 103 (FIGS. 5 and 8) of the previous example are thus eliminated, which helps reduce frictional losses between the housings of the bearings 124 and the rotor frame 96. The angled tracks 108, 110 also provide additional bending stiffness to the rotor frame 96. As shown in FIG. 16, the circumferential ends of each segment of the upper and lower tracks 108, 110 are angled with respect to a radial plane so that the joint between the first and second segments provides a gradually split surface such that each bearing 124 never encounters a location where the entire thickness of the bearing is at a track joint.

FIG. 19 also provides additional detail regarding the physical relationships among many of the previously described features that cannot be seen in the previous perspective views. For example, FIG. 19 show the construction of the stator core 114 with its base ring 107 entrapped axially between the teeth 95 of the upper and lower frame members 87, 89 and radially between the annular ring 91 and fingers 97 of the upper and lower frame members 87, 89 with the radially extending flanges 93 clamped between the clamping portions 125 of the upper and lower carriers 120, 122 of the bearing assemblies 20, 25. A coil 116 is shown wound around a radially extending pole 109 of the stator core 114, which opposes one of the magnets 102 of the flux ring 94 of the rotor 20 across an air gap AG.

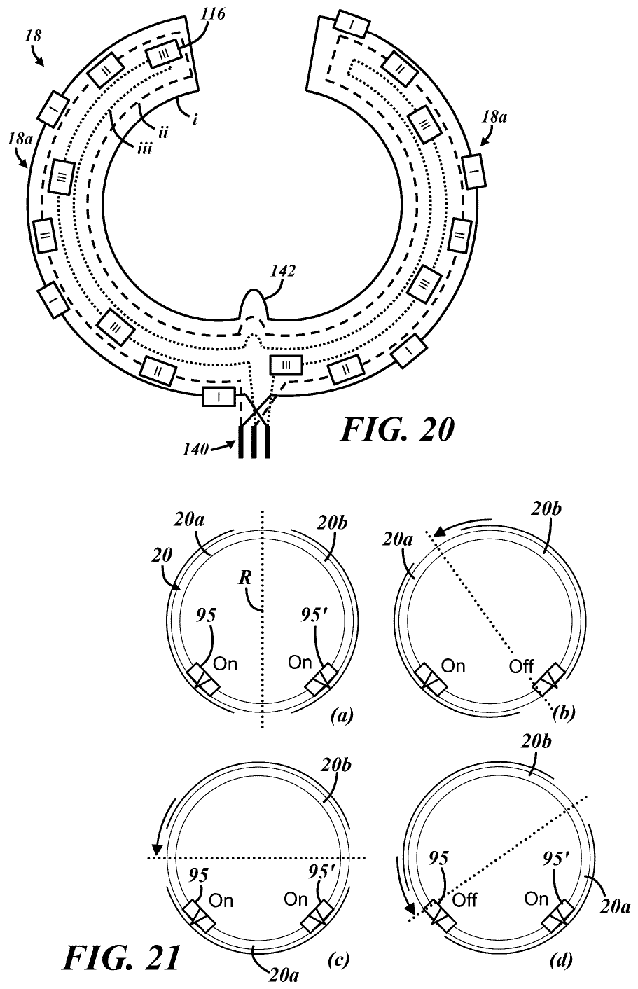

FIG. 20 is a schematic diagram of the stator windings. In this example, the stator 18 has the equivalent of eighteen coils 116 divided into 3-phases (I, II, III). In a conventional 3-phase motor, each of three continuous windings is wound at every third coil location in multiple 360-degree passes around the stator core. In the illustrated stator 18, each of the three windings (i, ii, iii) starts at one of three leads 140 and is wound at every third coil location for only 180-degrees of the stator core—i.e., the full extent of one stator core segment—and then doubles back along the same stator core segment, along a loop 142 at the hinge joint of the actuator 12, then along the opposite stator core segment for 180-degrees before doubling back again toward the hinge joint and leads 140. This stator winding configuration allows for a segmented stator core, stator, and actuator by permitting the gap G of FIG. 5 to be formed while maintaining continuity of the stator windings. Excess winding wire may be provided at the hinge joint of the actuator to accommodate the small amount of separation of the stator segments 18a, 18b there.

In another embodiment, electrical connectors are provided on the windings at the end of the stator segments 18a, 18b so that the stator can be effectively wound in the conventional way while permitting temporary disconnection of each winding when the actuator is in the open condition.

FIGS. 21(a)-21(d) schematically illustrate operation of the dual-head encoder system illustrated in the segmented actuators 12 described above. In FIG. 21(a), the rotor 20 is illustrated at a first angular position, and a rotor split line R is illustrated where the two rotor segments 20a, 20b meet. First and second encoder heads 95, 95′ are located about 90-degrees apart with respect to the actuator axis. At this angular position of the rotor 20, neither of the encoder heads is near the intersection of the rotor split line R and the rotor, and both encoder heads can effectively track the angular position of the rotor relative to a home position or datum.

In FIG. 21(b), the rotor 20 is rotated to a second angular position approximately 35 degrees from the first angular position of FIG. 21(a). The second encoder head 95′ has encountered a discontinuity in the encoder tape during the rotation from the first angular position and is not providing angular position information. The encoder system relies on angular position information only from the first encoder head 95 when the second encoder head 95′ is at or near a discontinuity in the encoder tape.

In FIG. 21(c), the rotor 20 is rotated to a third angular position approximately 90 degrees from the first angular position of FIG. 21(a). The discontinuity in the encoder tape encountered by the second encoder head at the second angular position of FIG. 21(b) is now sufficiently far from the second encoder head 95′ to reliably use position information gathered by the second encoder head 95′. Angular position information is thus available from both encoder heads 95, 95′ at the angular position of FIG. 21(c).

In FIG. 21(d), the rotor 20 is rotated to a fourth angular position approximately 35 degrees from the third angular position of FIG. 21(c). The first encoder head 95 has encountered a discontinuity in the encoder tape during the rotation from the third angular position and is not providing angular position information. The encoder system relies on angular position information only from the second encoder head 95′ when the first encoder head 95 is at or near a discontinuity in the encoder tape.

The dual-head encoder system is thus capable of determining the angular position of the rotor at any angular position, even when one of the encoder heads encounters a discontinuity in the encoder tape. When one encoder head is at or near such a discontinuity, the other encoder head is relied on for angular position information. The encoders may be under the control of a controller to switch back and forth between encoder heads as necessary to avoid encounters with the encoder tape discontinuities resulting from the segmented actuator design. The system may be programmed to use only one encoder at a time and/or both encoders some of the time.

The above-described actuator and motion assistive device may include other unillustrated features, such as housings, electric power supplies, sensors, and one or more controllers that, for example, receive information pertinent to relative positions of device components, process that information, and/or control device components based on the received information.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Further, the term “electrically connected” and the variations thereof is intended to encompass both wireless electrical connections and electrical connections made via one or more wires, cables, or conductors (wired connections). Other terms are to be construed using their broadest reasonable meaning unless they are used in a context that requires a different interpretation.

1. A wearable motion assistive device comprising an actuator that circumscribes a natural or artificial portion of the body of a user when the user wears the device.

2. The device of claim 1, wherein the actuator comprises a stator and a rotor, the stator and the rotor each circumscribing said portion of the body of the user when the user wears the device.

3. The device of claim 1, wherein the actuator has a closed condition, in which the actuator fully circumscribes said portion of the body, and an open condition, in which the actuator only partially circumscribes said portion of the body, such that the actuator can be installed around or be removed from around said portion of the body in the open condition.

4. The device of claim 1, wherein the actuator comprises a first segment and a second segment that together circumscribe said portion of the body, the second segment being movable relative to the first segment to open or close a gap between the first and second segments such that the actuator can be installed around or removed from around said portion of the body by passing said portion of the body through the gap.

5. The device of claim 4, wherein the first and second segments rotate relative to each other about a hinge axis when the actuator is changed between the open and closed conditions.

6. The device of claim 1, further comprising:
a frame, wherein the actuator is mounted on the frame;
an appendage support configured to rotate with respect to the frame; and
a transmission coupling the actuator with the support to transmit actuator movement to rotational movement of the appendage support with respect to the frame.

7. The device of claim 6, wherein the frame extends along a leg of the user, the actuator circumscribes the leg of the user, and the support extends along a foot of the user when the user wears the device.

8. The device of claim 1, wherein the actuator is a shaftless motor comprising a stator and a rotor that rotate relative to each other about an actuator axis when the motor is energized.

9. The device of claim 8, wherein the motor comprises a bearing assembly that maintains a gap between the stator and the rotor and centers the stator with respect to the rotor.

10. The device of claim 9, wherein the bearing assembly comprises a plurality of bearings circumferentially spaced and mounted on a carrier.

11. The device of claim 10, wherein each bearing of the plurality of bearings has a rotational axis that forms an obtuse angle with a rotational axis of the actuator.

12. The device of claim 1, wherein the actuator comprises a stator, a rotor, and a bearing assembly, wherein at least one of the stator, the rotor, or the bearing assembly comprises a first segment and a second segment that are movable relative to each other to open or close a gap between the first and second segments, the actuator being operable to rotate the rotor when the gap is closed and installable around or removable from around said portion of the body when the gap is open.

13. A prosthesis comprising the device of claim 1.

14. An electromechanical exoskeleton comprising the device of claim 1.

15. The electromechanical exoskeleton of claim 14, wherein the actuator is configured to circumscribe a natural or artificial leg of the user to assist foot movement about an ankle joint.

16. An electric motor comprising a stator, a rotor, and a bearing assembly, wherein at least one of the stator, the rotor, or the bearing assembly comprises a first segment and a second segment that are movable relative to each other to open or close a gap between the first and second segments, the motor being operable to rotate the rotor when the gap is closed and installable around an elongate object by passing the object through the gap when the gap is open.

17. An electromechanical exoskeleton comprising the electric motor of claim 16.

18. A bearing assembly comprising a plurality of bearings circumferentially arranged and mounted on a carrier, wherein the bearing assembly has an effective outer diameter at least two times greater than an outer diameter of each of the plurality of bearings.

19. The bearing assembly of claim 18, wherein each of the plurality of bearings is a radial roller bearing or ball bearing.

20. The bearing assembly of claim 18, wherein the carrier comprises first and second circumferential segments having respective ends that are separable from each other.
